(19) United States
(12) Patent Application Publication
(10) Pub. No.: US 2010/0177333 A1
(43) Pub. Date: Jul. 15, 2010

(54) Printing Apparatus, Printing Method and Printing Program

(75) Inventor: Yuji Nakagaki, Chiba (JP)

Correspondence Address: CROWELL & MORING LLP;INTELLECTUAL PROPERTY GROUP, P.O. BOX 14300, WASHINGTON, DC, 20044-4300, US

(73) Assignee: SEIKO Precision Inc., Narashino-shi (JP)

(21) Appl. No.: 12/663,358

(22) PCT Filed: Jun. 5, 2008
(86) PCT No.: PCT/JP2008/060366

§ 371 Date: Dec. 7, 2009

(30) Foreign Application Priority Data
Jun. 7, 2007 (JP) 2007-151828

(51) Int. Cl. G06K 15/02

(52) U.S. Cl. 358/1.12

(57) ABSTRACT

When an encoder (30) detects stopping of feeding of a print medium (50), a control unit (40) moves the position of a print head in a feed direction (Y direction) of the print medium (50) by a predetermined distance corresponding to deviation caused when printing is resumed. When the encoder (30) detects resumption of feeding of the print medium (50), the control unit (40) causes the print head to eject ink at a position to which the print head is moved in the feed direction, thereby resuming printing.

### TECHNICAL FIELD

The present invention relates to a printing apparatus, a printing method and a printing program.

### BACKGROUND ART

There is a printing apparatus which is attached to an existing film wrapping apparatus to wrap foods or the like with a film, and prints an expiry date or the like on the film to be fed. Because the film is fed by a film feeding mechanism of the film wrapping apparatus, such a printing apparatus cannot control feeding of the film. In this respect, there has been proposed a printing apparatus which prints at a predetermined print position of a print medium upon detection of the feeding state of the print medium by an encoder (see Patent Literature 1, for example).

When the encoder detects stopping of feeding of a print medium, the printing apparatus causes a print head to stop ejecting ink to stop printing. When stopping of feeding of the print medium is detected while printing a character, for example, the printing apparatus stops with printing of the character being incomplete (e.g., the character being half printed).

When the encoder detects resumption of feeding of the print medium, the printing apparatus causes the print head to eject ink to resume printing from the halfway. Patent Literature 1: Unexamined Japanese Patent Application KOKAI Publication No. 2007-62021

### DISCLOSURE OF THE INVENTION

### Problem to be Solved by the Invention

However, there is a slight time since detection of resumption of feeding of the print medium by the encoder until a control unit causes the print head to eject ink in response to the detection. Feeding of the print medium continues during that period of time. Printing is not done on that portion of the print medium which has passed under the print head while the print head stops ejecting ink, so that a character or figure printed is printed misaligned as if it were cut away from a middle.

The present invention has been made in view of the above situation, and it is an object of the invention to provide a printing apparatus, a printing method and a printing program which can resume printing without misalignment of a printed character or figure even if printing has been stopped halfway.

### Means for Solving the Problem

A printing apparatus according to the present invention comprises:

a print head that ejects ink to a print medium to be fed in a predetermined direction;

a print information storage section that stores print information to be printed on the print medium;

a print head control section that causes the print head to eject ink based on the print information stored in the print information storage section;

a feed stop detection section that detects that feeding of the print medium is stopped;

a print stop section that causes the print head to stop ejecting ink in response to detection of stopping of feeding of the print medium by the feed stop detection section;

a print state information storage section that stores print state information indicating a state of printing done based on the print information, when ejection of ink is stopped by the print stop section;

a print head moving section that moves the print head in the predetermined direction by a predetermined distance corresponding to a feeding distance by which the print medium is fed until ejection of ink by the print head is resumed after resumption of feeding of the print medium;

a feed resumption detection section that detects feeding of the print medium is resumed; and

a print resuming section that causes the print head to resume ejecting ink based on the print state information stored in the print state information storage section in response to detection of resumption of feeding of the print medium by the feed resumption detection section.

It is preferable that the printing apparatus according to the present invention should further comprise a print head returning section that moves the print head in a direction opposite to the predetermined direction by the predetermined distance by which the print head is moved by the print head moving section after waiting for resumption of printing by the print resuming section.

A printing method according to the present invention comprises:

a feed stop detection step in which a feed stop detection section detects that feeding of a print medium is stopped;

a print stop step in which a print stop section causes a print head to stop ejecting ink in response to detection of stopping of feeding of the print medium by the feed stop detection section;

a print state information storage step in which a print state information storage section stores print state information indicating a state of printing done based on print information stored in a print information storage section, when ejection of ink is stopped by the print stop section;

a print head moving step in which a print head moving section moves the print head in a predetermined direction, in which the print medium is fed, by a predetermined distance corresponding to a feeding distance by which the print medium is fed until ejection of ink by the print head is resumed after resumption of feeding of the print medium;

a feed resumption detection step in which a feed resumption detection section detects feeding of the print medium is resumed; and

a print resuming step in which a print resuming section causes the print head to resume ejecting ink based on the print state information stored in the print state information storage section in response to detection of resumption of feeding of the print medium by the feed resumption detection section.

A printing program according to the present invention allows a computer to execute:

a feed stop detection procedure in which a feed stop detection section detects that feeding of a print medium is stopped;

a print stop procedure in which a print stop section causes a print head to stop ejecting ink in response to detection of stopping of feeding of the print medium by the feed stop detection section;

a print state information storage procedure in which a print state information storage section stores print state information indicating a state of printing done based on print information stored in a print information storage section, when ejection of ink is stopped by the print stop section;

a print head moving procedure in which a print head moving section moves the print head in a predetermined direction, in which the print medium is fed, by a predetermined distance corresponding to a feeding distance by which the print medium is fed until ejection of ink by the print head is resumed after resumption of feeding of the print medium;

a feed resumption detection procedure in which a feed resumption detection section detects feeding of the print medium is resumed; and

a print resuming procedure in which a print resuming section causes the print head to resume ejecting ink based on the print state information stored in the print state information storage section in response to detection of resumption of feeding of the print medium by the feed resumption detection section.

### EFFECT OF THE INVENTION

The present invention can provide a printing apparatus, a printing method and a printing program which can resume printing without misalignment of a printed character or figure even if printing has been stopped halfway.

### BRIEF DESCRIPTION OF DRAWINGS

FIG. 1 is a perspective view illustrating one example of a printing apparatus according to an embodiment of the present invention;

FIG. 2 is a perspective view illustrating one example of a chassis of the printing apparatus according to an embodiment of the present invention;

FIG. 3A is a cross-section view of a print head of the printing apparatus according to an embodiment of the present invention;

FIG. 3B is a cross-section view of the print head of the printing apparatus according to an embodiment of the present invention;

FIG. 4 is a perspective view illustrating the structures of a print head and a nozzle surface of the printing apparatus according to an embodiment of the present invention;

FIG. 5 is a diagram illustrating one example of a flowchart of a print stopping process;

FIG. 6 is a diagram illustrating one example of a flowchart of a printing resuming process;

FIG. 7A is a diagram for explaining that misalignment does not occur when printing is resumed;

FIG. 7B is a diagram for explaining that misalignment does not occur when printing is resumed;

FIG. 7C is a diagram for explaining that misalignment does not occur when printing is resumed; and

FIG. 8 is a diagram illustrating one example of a timing chart illustrating the relationship among a feeding state of a print medium, ejection of ink from the print head, and movement of the print head when printing is resumed.

### DESCRIPTION OF REFERENCE NUMERALS

1 printing apparatus
10 print unit
11 print head
16 holder
17 holder guide
17a guide rail
20 feed unit
21 feed roller
21a shaft
21b rotary portion
22 platen roller
22a shaft
22b rotary portion
23, 24 floor board
24a window
25 support board
30 encoder
30a driven roller
40 control unit
50 print medium
50a registered mark
60 input/output unit
70 storage unit
80 print head control circuit
111a printing head
111b nozzle surface
111c nozzle holes
151 chassis

### BEST MODE FOR CARRYING OUT THE INVENTION

A printing apparatus according to an embodiment of the present invention will be described below with reference to the accompanying drawings.

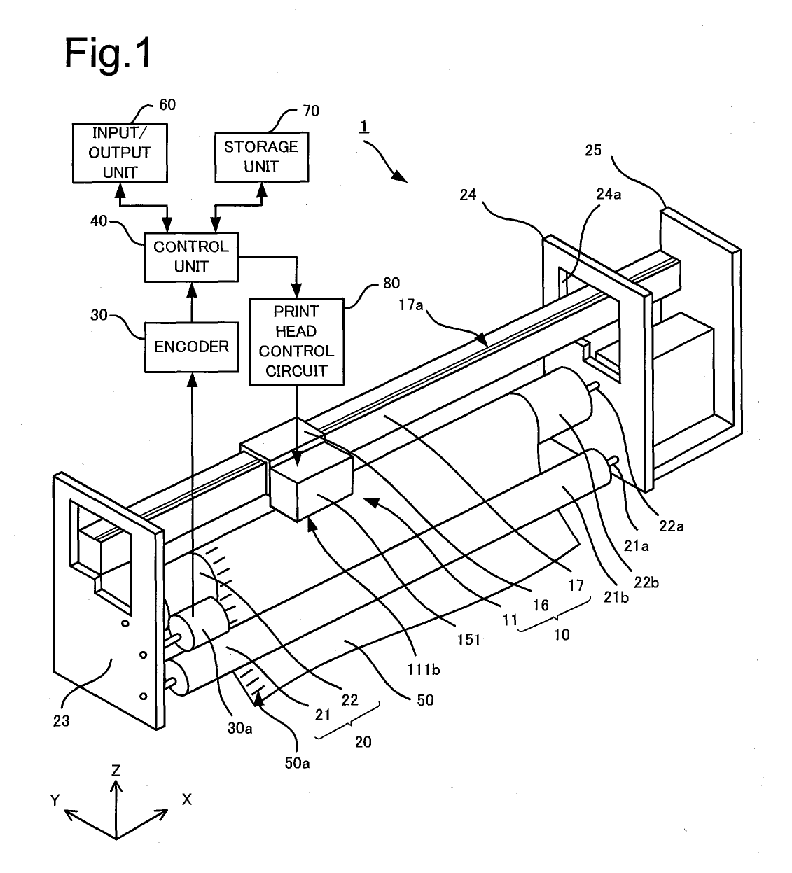

FIG. 1 is a perspective view illustrating one example of a printing apparatus 1 according to one embodiment of the present invention.

As illustrated in FIG. 1, the printing apparatus 1 comprises a print unit 10 and a feeding unit 20. The printing apparatus 1 is attached to an existing film wrapping apparatus to wrap foods or the like with a film, and prints an expiry date or the like on a film (print medium 50) to be fed.

The print unit 10 comprises a print head 11, a holder 16, and a holder guide 17.

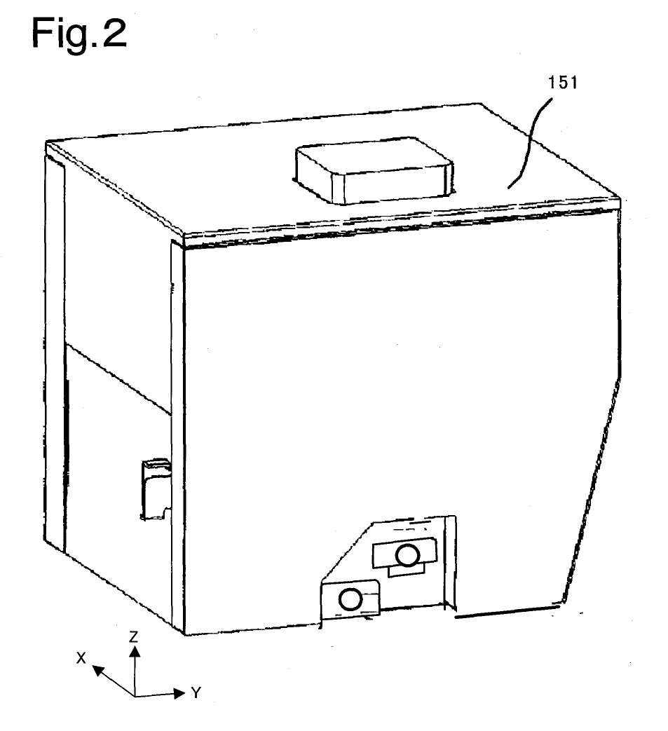

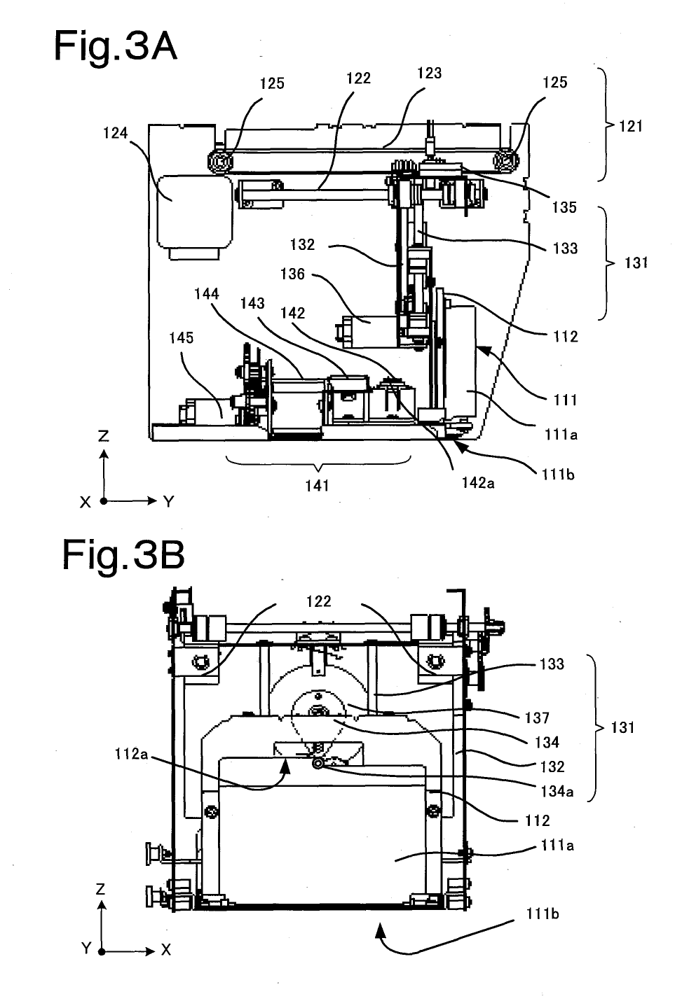

FIG. 2 is a perspective view illustrating one example of a chassis of the print head 11, and FIGS. 3A and 3B are cross-section views of the print head 11. The print head 11 has a print head unit 111, a print head carrier 112, a horizontal movement mechanism 121, a vertical movement mechanism 131, a maintenance mechanism 141, and a chassis 151.

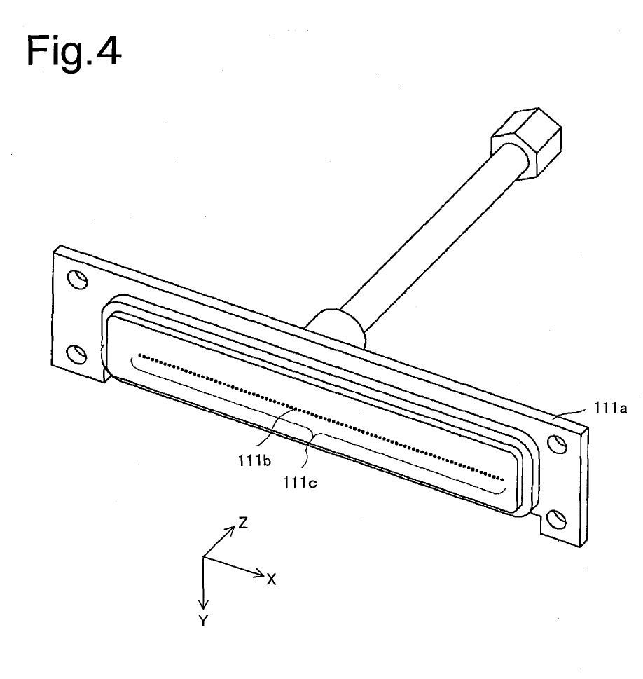

The print head unit 111 has a printing head 111a inside the chassis 151 of an approximately rectangular solid shape. As illustrated in FIG. 4, a plurality of nozzle holes 111c which eject ink supplied from an unillustrated ink cartridge are formed in a bottom face or nozzle face 111b of the printing head 111a at predetermined intervals along the lengthwise direction (the X direction) of the nozzle face 111b.

The print head carrier 112 is a tabular member in which an aperture 112a is formed. The print head carrier 112 holds the print head unit 111 in such a way as to face a platen roller 22 with the nozzle face 111b of the print head unit 111 being directed downward.

As illustrated in FIGS. 3A and 3B, the horizontal movement mechanism 121 has horizontal guide shafts 122, a timing belt 123, and a motor 124.

The horizontal guide shaft 122 is a bar member arranged in a Y direction (horizontal direction (direction orthogonal to the vertical direction in which the print head unit 111 moves close to and away from the platen roller 22 and orthogonal to the extending direction of the platen roller 22)).

The timing belt 123 is a belt-like member which does not stretch. The timing belt 123 is hung by a pair of pulleys 125.

The motor 124 is a stepping motor. The motor 124 rotates and drives one of the pair of pulleys 125 to rotate the timing belt 123.

The vertical movement mechanism 131 comprises a frame 132, vertical guide shafts 133, a cam 134, a belt holding part 135, and a motor 136.

The frame 132 is inserted over the horizontal guide shafts 122 of the horizontal movement mechanism 121 in a slidable manner. The frame 132 holds the print head carrier 112.

The vertical guide shaft 133 is a bar member arranged in a Z direction (vertical direction (direction in which the print head unit 111 moves close to and away from the platen roller 22)) with respect to the frame 132.

The cam 134 is provided at one end with a lobe 134a which slides in contact with the aperture 112a of the print head carrier 112. The cam 134 is fixed to a rotor plate 137.

The belt holding part 135 is fixed to the frame 132. The belt holding part 135 holds a part of the timing belt 123 of the horizontal movement mechanism 121 from both sides, and is fixed to a part of the timing belt 123. As the motor 124 rotates the timing belt 123, the vertical movement mechanism 131 is moved together with the print head unit 111 in the Y direction along the horizontal guide shaft 122.

The motor 136 is a stepping motor. The motor 136 rotates the rotor plate 137.

The maintenance mechanism 141 is disposed adjacent to the print head unit 111 in the Y direction. The maintenance mechanism 141 comprises a cap unit 142, a cleaner unit 143, and a wiper unit 144.

The cap unit 142 holds a cap 142a. The cap 142a covers the nozzle face 111b to prevent the nozzle holes 111c from being dried. The cap unit 142 deairs the interior of the cap 142a with an unillustrated pump for depressurization, thereby aspirating and cleaning up foreign matter or excess ink on the nozzle face 111b.

After the cap unit 142 aspirates the foreign matter or excess ink on the nozzle face 111b, the wiper unit 144 drives a wiper blade with a drive motor 145 to scrape the ink resident on the nozzle face 111b.

After scraping the ink with the wiper unit 144, the cleaner unit 143 dissolves and cleans the ink resident on the nozzle face 111b of the printing head 111a.

The chassis 151 accommodates the print head unit 111, the horizontal movement mechanism 121, the vertical movement mechanism 131, and the maintenance mechanism 141. The chassis 151 comprises an unillustrated aperture at its bottom surface which exposes the nozzle face 111b of the print head unit 111.

The holder 16 holds the print head 11 in a detachable manner. The holder 16 can move in the X direction along a guide rail 17a formed at the holder guide 17.

Apparently, the horizontal movement mechanism 121 and the vertical movement mechanism 131 can allow the printing head 111a of the print head 11 to move in the Y direction and the Z direction, respectively. In addition, the movement of the holder 16 can move the printing head 111a in the X direction too.

The holder guide 17 is a member of an approximately rectangular solid shape extending in the X direction. The guide rail 17a is formed on the upper surface (the Z direction) of the holder guide 17 along the lengthwise direction (the X direction). The holder guide 17 penetrates a window 24a of a floor board 24, and has both ends fixed to a floor board 23 and a support board 25.

The feeding unit 20 comprises a feed roller 21 and the platen roller 22.

The feed roller 21 comprises a shaft 21a and a cylindrical rotary portion 21b. The shaft 21a is arranged approximately horizontally in the X direction, and has both ends fixed to the floor boards 23 and 24, respectively. The rotary portion 21b is arranged rotatable around the fixed shaft 21a.

The platen roller 22 comprises a shaft 22a and a cylindrical rotary portion 22b. The shaft 22a is arranged approximately horizontally in the X direction, and has both ends fixed to the floor boards 23 and 24, respectively. The rotary portion 22b is arranged rotatable around the fixed shaft 22a.

The feed roller 21 and the platen roller 22 are driven rollers which do not have a drive source and rotate as the print medium 50 is fed.

The floor boards 23, 24 are disposed in parallel to each other so as to be orthogonal to the shafts 21a, 22a.

A driven roller 30a is fixed to the floor board 23. The driven roller 30a holds the print medium 50 with the platen roller 22 (contacts the top surface of the print medium 50). The driven roller 30a rotates as the print medium 50 is fed, and the number of its rotations (i.e., the distance by which the print medium 50 has been fed) is detected by an encoder 30. The encoder 30 detects stopping of feeding of the print medium 50, and sends a predetermined signal to a control unit 40.

An input/output unit 60 includes a display device (output device) and an input device. The display device (output device) displays (outputs) an image supplied from the control unit 40, e.g., an image for instructing a user to perform various operations, an image for warning the user, and so forth. The input device inputs various kinds of data and operations.

A storage unit 70 includes a memory, such as ROM (Read Only Memory), RAM (Random Access Memory) or flash memory, and a hard disk. The storage unit 70 stores print information input through the input/output unit 60, and supplies the print information to the control unit 40. The print information includes print character information and print position information specifying a position for a string of characters. The print character information specifies a string of characters (text, symbol, numeral, pictogram or the like) to be printed. The print position information specifies a position for a string of characters. The print position information is information specifying, for example, which positions in the widthwise direction and lengthwise direction of the print medium 50 a string of characters is to be printed.

The control section 40 includes an MPU (Micro Processing Unit), and various memories, such as ROM and RAM. Print information can be input directly to a memory in the control unit 40 from an input device of the input/output unit 60.

The control unit 40 converts print character information included in print information to dot pattern data (data designating whether individual dots are to be printed), and outputs the data to the print head control circuit 80.

The control unit 40 moves the holder 16 to a specific position in the widthwise direction (the X direction) of the print medium 50 based on the print position information.

The print head control circuit 80 comprises a print buffer (dot pattern memory), and a driver circuit which controls ejection of ink from the nozzle holes 111c of the printing head 111a. The print head control circuit 80 receives the dot pattern data from the control unit 40 and stores the data in the print buffer. The print head control circuit 80 controls the nozzle holes 111c to eject ink, according to the dot pattern data stored in the print buffer.

The print medium 50 is, for example, a PET (polyethylene terephthalate) or PP (polypropylene) film.

The print medium 50 is provided with a registered mark 50a. An unillustrated sensor reads the registered mark 50a. Based on the registered mark 50a and the number of rotations of the driven roller 30a detected by the encoder 30, the timing of performing printing on the print medium 50 (timing of ejecting ink from the printing head 111a) is determined.

Next, a description will be given of the operation of the printing apparatus 1 when feeding of the print medium 50 is stopped during printing and feeding of the print medium 50 is resumed thereafter.

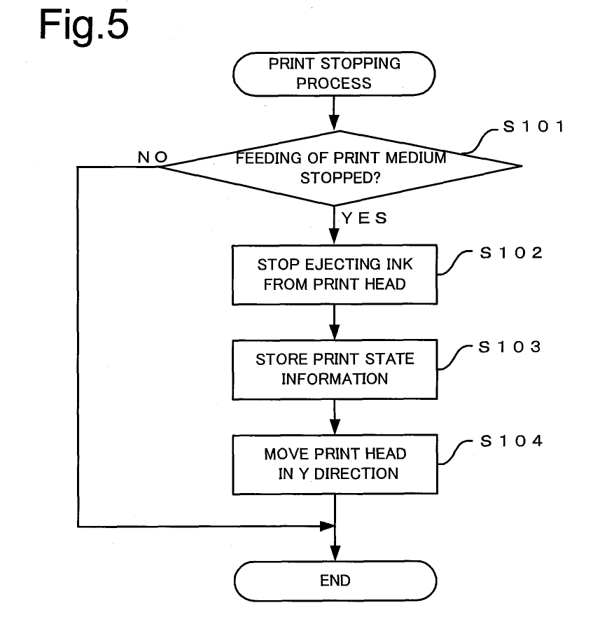

When the control unit 40 receives a signal indicating stopping of feeding of the print medium 50 from the encoder 30 during printing on the print medium 50 by the printing apparatus 1 based on print information stored in the storage unit 70 (step S101; Yes), the control unit 40 performs a print stopping process in FIG. 5.

When stopping of feeding of the print medium is not detected (step S101; No), the control unit 40 does not perform the print stopping process.

When the control unit 40 receives the signal indicating stopping of feeding of the print medium 50 from the encoder 30 and detects that feeding of the print medium is stopped (step S101; Yes), the control unit 40 causes the print head control circuit 80 to stop ejecting ink from the printing head 111a (step S102).

Subsequently, the control unit 40 acquires from the print head control circuit 80 print state information indicating to which dot corresponding to the dot pattern data stored in the print buffer has been printed when ejection of ink from the printing head 111a has been stopped, and stores the print state information in the storage unit 70 (step S103). The control unit 40 may store the print state information in a memory in the control unit 40.

Subsequently, the control unit 40 causes the motor 124 of the horizontal movement mechanism 121 in the print head 11 to move the printing head 111a only by a predetermined distance (e.g., 0.7 mm) in the Y direction (feeding direction of the print medium 50) (step S104).

The predetermined distance is the distance which does not cause printing misalignment (unprinted portion). The predetermined distance is acquired beforehand and stored in the storage unit 70.

For example, the predetermined distance is set to a value equal to the distance by which the print medium 50 is fed until ejection of ink through the nozzle holes 111c of the printing head 111a is resumed after resumption of feeding of the print medium 50. It is to be noted however that the value should not necessarily be equal to the distance.

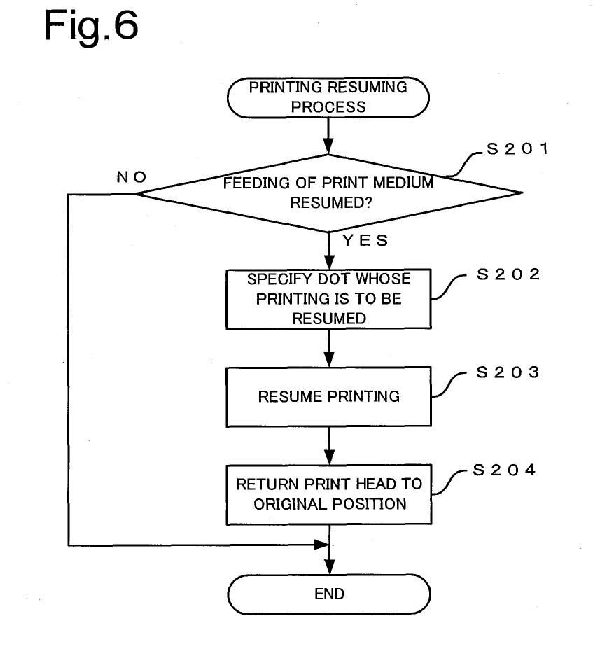

Thereafter, when the encoder 30 detects resumption of feeding of the print medium 50, the encoder 30 sends a signal indicating the resumption to the control unit 40. When the signal is input to the control unit 40 (step S201; Yes), the control unit 40 performs a printing resuming process shown in FIG. 6.

When resumption of feeding of the print medium is not detected (step S201; No), the control unit 40 does not perform the print stopping process.

When the control unit 40 receives the signal indicating resumption of feeding of the print medium 50 from the encoder 30 and detects that feeding of the print medium is resumed (step S201; Yes), the control unit 40 specifies a dot whose printing is to be resumed based on the print state information stored in a memory in the control unit 40 or the storage unit 70 in step S103 (step S202).

Subsequently, the control unit 40 causes the print head control circuit 80 to eject ink from the printing head 111a to resume printing so that printing will start from the dot specified in step S202 (step S203).

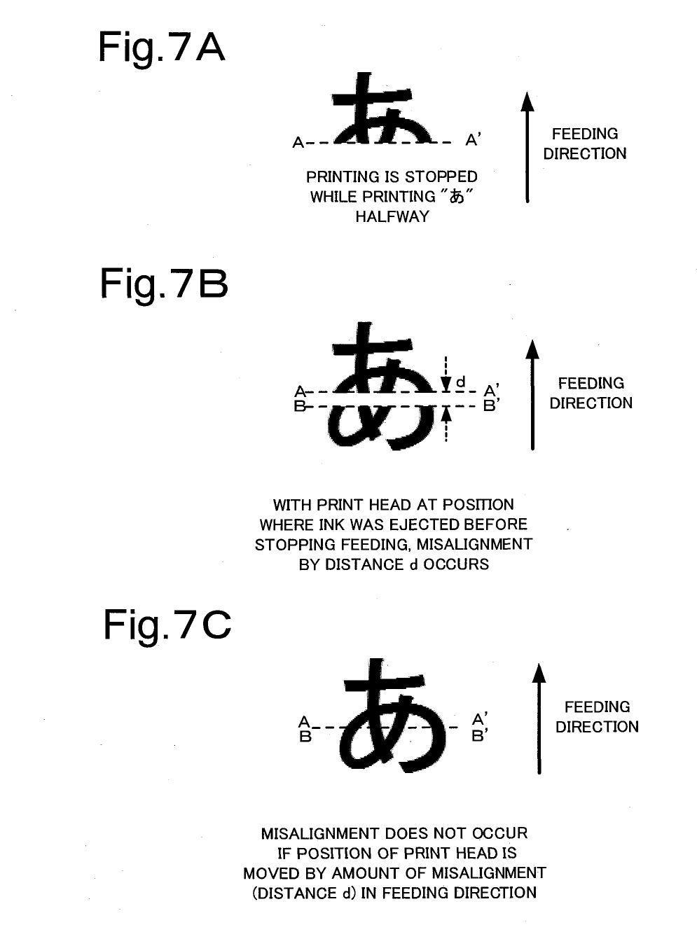

At this time, as illustrated in FIG. 7, printing misalignment does not occur between the portion printed before the resumption of printing and the portion printed after the resumption of printing.

FIG. 7A is a diagram illustrating a Japanese character [symbol] printed on the print medium 50 at the time when printing is stopped as a result of stopping of feeding of the print medium 50 during printing with the printing apparatus 1. As illustrated, the character [symbol] is printed halfway (up to a broken line A-A′).

When feeding of the print medium 50 is resumed from that state thereafter, the print medium 50 is fed by a distance d until the control unit 40 resumes ejection of ink. As illustrated in FIG. 7B, therefore, when the control unit 40 causes the printing head 111a to eject ink at the position where ink has been ejected before stopping of the feeding, the position at which printing is done when the printing is resumed (broken line B-B′) does not match with the position at which printing was done when the printing was stopped (broken line A-A′). Misalignment by the distance d occurs in the printed character

[symbol]

According to the embodiment, however, through the process of step S103, the control unit 40 moves the printing head 111a by a distance equivalent to the misalignment distance d in the feeding direction of the print medium when printing is stopped. Accordingly, as illustrated in FIG. 7C, the position at which ejection of ink is resumed (broken line B-B′) matches with the position at which ejection of ink was stopped (broken line A-A′). Therefore, the character [symbol] is printed without causing misalignment.

Subsequently, the control unit 40 causes the motor 124 of the horizontal movement mechanism 121 in the print head 11 to move the printing head 111a by the distance d in step S103, in the opposite direction to the feeding direction (the Y direction) of the print medium 50 (i.e., to return to the original position) (step S204).

When the printing head 111a is ejecting ink, the control unit 40 temporarily interrupts movement of returning the printing head 111a to the original position.

When the printing head 111a returns to the original position, the control unit 40 terminates the printing resuming process.

Then, the control unit 40 determines the timing of printing on the print medium 50 (timing of ejecting ink from the printing head 111a) based on the registered mark 50a and the number of rotations of the driven roller 30a detected by the encoder 30, and causes the printing head 111a to eject ink based on the print information stored in the storage unit 70.

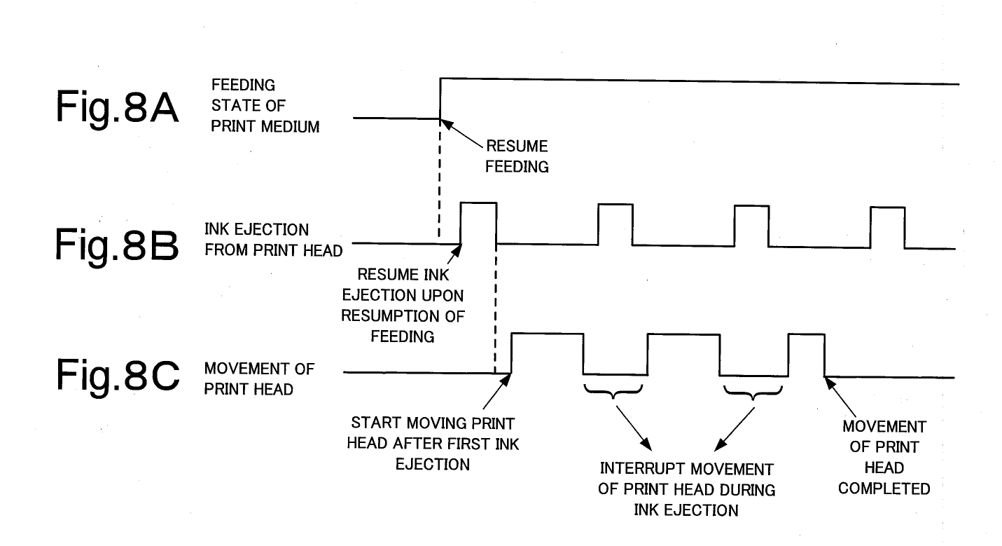

FIGS. 8A to 8C show one example of a timing chart illustrating the relationship among the feeding state of the print medium 50, ejection of ink from the printing head 111a, and movement of the printing head 111a when printing is resumed.

When the encoder 30 detects resumption of feeding of the print medium 50, as illustrated in FIG. 8A, the control unit 40 causes the printing head 111a to resume ejecting ink as illustrated in FIG. 8B. After first ink ejection is finished, the control unit 40 moves and returns the printing head 111a to the original position before printing was stopped, as illustrated in FIG. 8C.

During ink ejection, however, the movement of the printing head 111a is interrupted. As illustrated in FIGS. 8B and 8C, the movement of the printing head 111a is interrupted at the time of the second and third ink ejections after resumption of printing. As illustrated in FIGS. 8B and 8C, the movement of the printing head 111a is completed after the third ink ejection after resumption of printing.

The control unit 40 has an unillustrated sensor disposed, for example, near the printing head 111a to measure the position of the printing head 111a, and determines whether the movement of the printing head 111a is completed based on the measurement of the position by the sensor.

Alternatively, the control unit 40 may determine that the movement of the printing head 111a is completed when the moving distance of the printing head 111a reaches the distance by which the printing head 111a has been moved in the Y direction when feeding of the print medium 50 is stopped.

The control unit 40 determines the timing of printing on the print medium 50 (timing of ejecting ink from the printing head 111a) based on the registered mark 50a and the number of rotations of the driven roller 30a detected by the encoder 30. Therefore, the control unit 40 knows the timing at which the printing head 111a is not ejecting ink. If the control unit 40 moves the printing head 111a while the printing head 111a is not ejecting ink, therefore, it does not hinder printing.

Alternatively, the control unit 40 may control the time at which the printing head 111a ejects the ink and the time at which the printing head 111a moves by means of a timer.

The movement of the printing head 111a may not be carried out in multiple times. For example, if the interval between the first ink ejection and the second ink ejection is sufficiently long, the printing head 111a can return to the original position in one movement.

As apparent from the above, when printing is stopped, the printing apparatus 1 according to the embodiment moves the printing head 111a in the feeding direction of the print medium 50 by a predetermined distance corresponding to the feeding distance in which the print medium 50 is fed until ink ejection from the printing head 111a is resumed after resumption of feeding of the print medium 50. Then, when printing is resumed, ink ejection from the printing head 111a is resumed from the moved position, so that the printing apparatus 1 does not have printing misalignment when printing is resumed.

The present invention is not to be limited to the foregoing embodiment, but may be modified and applied in various forms. According to the embodiment, for example, in the print stopping process, the control unit 40 carries out the process of moving the printing head 111a in the feeding direction of the print medium 50 (step S104) after the process of acquiring and storing print state information (step S103). However, the processes need not be carried out in this order, and the control unit 40 may carry out the processes in the reverse order or simultaneously. Further, the control unit 40 may carry out the process of moving the printing head 111a in the feeding direction of the print medium 50 (step S104) when a predetermined time elapses after printing is stopped. The process of moving the printing head 111a in the feeding direction of the print medium 50 (step S104) may be executed by the control unit 40 at any timing as long as it is executed by the time when printing resumes after stoppage of printing.

It is desirable that the X direction, the Y direction and the Z direction shown in FIG. 1 be at right angles to one another, which is not however restrictive.

The illustrated materials, the quantities and shapes in the embodiment can be changed arbitrarily, and may be selected according to the usage and purpose as needed.

According to the embodiment, it is assumed that the printing apparatus 1 is attached to, for example, an existing film wrapping apparatus and the film feeding mechanism cannot be controlled by the printing apparatus 1. When the printing apparatus cannot control the feeding state of the film in this case, the embodiment is particularly effective. It is needless to say that the present invention can be adapted to a printing apparatus configured separately from a film wrapping apparatus so that the printing apparatus can control the film feeding mechanism.

While the embodiment of the present invention has been described above, various corrections and combinations needed for the sake of design convenience or other factors are to be regarded to be included in the scope of the invention described in the attached claims or the invention corresponding to specific examples described in the description of the embodiment.

This application is based on Japanese Patent Application No. 2007-151828 filed on Jun. 7, 2007 incorporating the specification, claims, and drawings herein by reference in the entirety,

### INDUSTRIAL APPLICABILITY

The present invention can be used in printers.

1. A printing apparatus comprising:
a print head that ejects ink to a print medium to be fed in a predetermined direction;
a print information storage section that stores print information to be printed on the print medium;
a print head control section that causes the print head to eject ink based on the print information stored in the print information storage section;
a feed stop detection section that detects that feeding of the print medium is stopped;
a print stop section that causes the print head to stop ejecting ink in response to detection of stopping of feeding of the print medium by the feed stop detection section;
a print state information storage section that stores print state information indicating a state of printing done based on the print information, when ejection of ink is stopped by the print stop section;
a print head moving section that moves the print head in the predetermined direction by a predetermined distance corresponding to a feeding distance by which the print medium is fed until ejection of ink by the print head is resumed after resumption of feeding of the print medium;
a feed resumption detection section that detects feeding of the print medium is resumed; and
a print resuming section that causes the print head to resume ejecting ink based on the print state information stored in the print state information storage section in response to detection of resumption of feeding of the print medium by the feed resumption detection section.

2. The printing apparatus according to claim 1, further comprising a print head returning section that moves the print head in a direction opposite to the predetermined direction by the predetermined distance by which the print head is moved by the print head moving section after waiting for resumption of printing by the print resuming section.

3. A printing method comprising:
a feed stop detection step in which a feed stop detection section detects that feeding of a print medium is stopped;
a print stop step in which a print stop section causes a print head to stop ejecting ink in response to detection of stopping of feeding of the print medium by the feed stop detection section;
a print state information storage step in which a print state information storage section stores print state information indicating a state of printing done based on print information stored in a print information storage section, when ejection of ink is stopped by the print stop section;
a print head moving step in which a print head moving section moves the print head in a predetermined direction, in which the print medium is fed, by a predetermined distance corresponding to a feeding distance by which the print medium is fed until ejection of ink by the print head is resumed after resumption of feeding of the print medium;
a feed resumption detection step in which a feed resumption detection section detects feeding of the print medium is resumed; and
a print resuming step in which a print resuming section causes the print head to resume ejecting ink based on the print state information stored in the print state information storage section in response to detection of resumption of feeding of the print medium by the feed resumption detection section.

4. A printing program allowing a computer to execute:
a feed stop detection procedure in which a feed stop detection section detects that feeding of a print medium is stopped;
a print stop procedure in which a print stop section causes a print head to stop ejecting ink in response to detection of stopping of feeding of the print medium by the feed stop detection section;
a print state information storage procedure in which a print state information storage section stores print state information indicating a state of printing done based on print information stored in a print information storage section, when ejection of ink is stopped by the print stop section;
a print head moving procedure in which a print head moving section moves the print head in a predetermined direction, in which the print medium is fed, by a predetermined distance corresponding to a feeding distance by which the print medium is fed until ejection of ink by the print head is resumed after resumption of feeding of the print medium;
a feed resumption detection procedure in which a feed resumption detection section detects feeding of the print medium is resumed; and
a print resuming procedure in which a print resuming section causes the print head to resume ejecting ink based on the print state information stored in the print state information storage section in response to detection of resumption of feeding of the print medium by the feed resumption detection section.
